(19) United States
(12) Patent Application Publication
(10) Pub. No.: US 2018/0183826 A1
(43) Pub. Date: Jun. 28, 2018

(54) DESIGN SUPPORT SYSTEM

(71) Applicant: RENESAS ELECTRONICS EUROPE LIMITED, Buckinghamshire (GB)

(72) Inventors: Marco Demi, Buckinghamshire (GB); Maria Carmela Simone, Buckinghamshire (GB); Samson Bisase, Buckinghamshire (GB); Berardino Carnevale, Buckinghamshire (GB); Donato Luongo, Buckinghamshire (GB); Harman Hunjan, Buckinghamshire (GB)

(21) Appl. No.: 15/754,100

(22) PCT Filed: Aug. 21, 2015
(86) PCT No.: PCT/GB2015/052435

§ 371 Date: Feb. 21, 2018

(51) Int. Cl. H04L 29/06; H04L 29/08

(52) U.S. Cl. CPC H04L 63/1433; H04L 67/12; H04L 63/205

(57) ABSTRACT

A method of and a design support system for generating a risk profile for at least part of an electronic system which is vulnerable to an attack originating from outside the system are described. The method comprises receiving an attack scenario identifying an attack and a potential target for the attack within the at least part of the system, receiving a selection, from a user, of a security analysis model for assessing the attack, receiving information identifying a selected security mechanism appliable in the at least part of an electronic system and generating a risk profile in dependence upon the security mechanism.

### FIELD OF THE INVENTION

The present invention relates to a design support system which can generate a risk profile for at least part of an electronic system and to a method of generating a risk profile for at least part of an electronic system, such as a network of electronic control units in a vehicle, such as a motor vehicle, or an industrial control system, which is vulnerable to an attack originating from outside the system.

### BACKGROUND

Electronic control units (ECUs) are increasingly being introduced into motor vehicles in a wide range of automotive domains such as powertrain, chassis, body, active safety, driver assistance, passenger comfort and infotainment. Not only is the number of ECUs embedded in a vehicle rising, but also these units are becoming ever more interconnected by communication buses, such as control area network (CAN), FlexRay, Media Oriented Systems Transport (MOST) and Ethernet.

Control units are also becoming more prevalent in industrial control systems used in, for example, manufacturing or processing plants, as well as in medical systems.

As with any networked computer system, automotive electronic systems and industrial control systems are vulnerable to attack by external malicious entities. Thus, attention is being directed to designing secure automotive electronic systems and industrial control systems.

One project, E-Safety Vehicle Intrusion Protected Applications (EVITA), had the objectives of designing, verifying and prototyping a secure architecture for automotive on-board electronics networks. An overview of EVITA is given in Hervé Seudie: “EVITA-Project.org: E-Safety Vehicle Intrusion Protected Applications”, 7th escar Embedded Security in Cars Conference Nov. 24-25, 2009, Düsseldorf.

According to EVITA, a risk level can be determined based on a severity and probability of attack, thereby allowing a user to assess risk.

Notwithstanding this, there is still a need for a design support system and a method of generating a risk profile which can help a designer to compare different designs of electronic system allowing them to assess security more quickly and/or fully, for example, by testing security of the system at different phases of a system lifecycle and, if necessary, tune counter measures.

### SUMMARY

According to a first aspect of the present invention there is provided a method of generating a risk profile for at least part of an electronic system which is vulnerable to an attack originating from outside the system. The method comprises receiving an attack scenario identifying an attack and a potential target for the attack within the at least part of the system, receiving a selection, from a user, of a security analysis model for assessing the attack, receiving information identifying a selected security mechanism appliable in the at least part of an electronic system and generating a risk profile in dependence upon the selected security mechanism.

This can allow a user to assess the impact of different security mechanisms, such as software-based encryption or hardware security modules, and so identify which security mechanisms should be implemented. The user can also compare results using different security analysis models which can provide further insights into the effectiveness of the selected security mechanism.

The at least part of an electronic system may be the whole electronic system, a part of the electronic system, a domain, or a component. A component may be integrated circuit, such as a microcontroller, system on a chip (SoC), memory, memory controller, application specific integrated circuit (ASIC) or field programmable gate array (FPGA). A component may be a module in an integrated circuit, such as a communications controller. A component may be a macro. A component may include software.

The security analysis model may be selected from a plurality of security analysis model which may include E-Safety Vehicle Intrusion Protected Applications (EVITA), Reliability, Safety and Mission assurance (RSMA), Common Vulnerability Scoring System (CVSS), STRIDE plus DREAD or other security analysis process which is applicable to an automotive, industrial, medical or other security-sensitive setting or domain.

The risk profile may comprise a value, such as a security level. The risk profile value may be an integer. The risk profile value may be positive. The risk profile value may take a value between a lower limit, which may be 0 or 1, and an upper limit, which may be 6, 7 or 8. The risk profile may comprise an array of at least two severity-related values including the value.

Generating the risk profile may comprise mapping an output for a security analysis model onto a predefined risk profile template according to a predefined scheme. This can help to compare results generated using more than one model.

The method may comprise generating another risk profile without the selected security mechanism. This can help a developer to assess the impact of the security mechanism by comparing risk profiles with and without the security measure in place. The other risk profile (i.e. the risk profile without the security mechanism) may be generated before the risk profile (i.e. the risk profile with the security mechanism) and, optionally, before receiving the information identifying the selected security mechanism. Thus, a computer system may generate an initial risk profile without any security mechanism and later generate a further risk profile with a selected security mechanism. The method may further comprise generating a report which includes the risk profile. The report may include the other risk profile without the selected security mechanism applied.

Receiving information about the selected security mechanism may comprise receiving a selection, from the user, of a security mechanism. The method may comprise selecting a security mechanism according to a predetermined method or rule, generating a risk profile in dependence upon the security mechanism, determining whether the risk profile meets a predetermined criterion and, in dependence upon determining that the risk profile meets the predetermined criterion, using the security mechanism as the selected security mechanism. In effect, this provides a way of automatically selecting a security mechanism which can help a user to find an acceptable security mechanism.

The attack scenario may be a first attack scenario and the risk profile may be a first risk profile. The method may further comprise receiving a second attack scenario identifying a second, different attack and the same target and generating a second risk profile in dependence upon the security mechanism.

The method may further comprise prompting the user as to whether the security mechanism is to be used for the second attack. The at least a portion of the system comprises a domain.

The electronic system may be an automotive electronic system. The electronic system may be an industrial electronic system. The electronic system may be a medical electronic system. The electronic system may by a system of interconnected devices, i.e. a system within the Internet-of-Things.

More than one security mechanism may be considered at the same time. Thus, the method may comprise receiving information about at least two selected security mechanisms appliable in the at least part of an electronic system and generating a risk profile in dependence upon the at least two security mechanisms.

According to a second aspect of the present invention there is provided a method of designing an electronic system. The method comprises generating a risk profile for at least part of the electronic system, including the security mechanism in a design of the at least part of the electronic system and storing the design.

According to a third aspect of the present invention there is provided a method of manufacturing a product or system incorporating the electronic system embodying a design comprising the design of the at least part of the electronic system.

The product may be a vehicle. The product may be a motor vehicle. The motor vehicle may be a motorcycle, an automobile (sometimes referred to as a “car”), a minibus, a bus, a truck or lorry. The motor vehicle may be powered by an internal combustion engine and/or one or more electric motors. The product may be a train vehicle, such as a drive unit (sometime referred to as a “train engine”) or a train carriage. The product may be an aerospace vehicle, such as an aeroplane or space vehicle.

The product may be a signalling device for use in a transport. The signalling device may be off-vehicle, for example, trackside signalling for a train.

The product may be a medical system, such as, monitors for monitoring vital signs such as heart rate, breathing rate et cetera. The medical system may include a remote device and a local device (“home device”) capable of wireless communication with the remote device. The remote device may be implantable.

The system may be an industrial system for use in manufacturing or processing.

According to a fourth aspect of the present invention there is provided a product manufactured by the method.

According to a fifth aspect of the present invention there is provided a computer program which, when executed by data processing apparatus, causes the data processing apparatus to perform the method.

According to a sixth aspect of the present invention there is provided a computer program product, which may be non-transitory, comprising a computer-readable medium storing the computer program.

According to a seventh aspect of the present invention there is provided a design support system which includes data processing apparatus comprising at least one processor and at least one set of memory. The at least one processor is configured to perform the method.

According to an eight aspect of the present invention there is provided a database storing security-related data which is categorized by domain and/or by attack.

### BRIEF DESCRIPTION OF THE DRAWINGS

Certain embodiments of the present invention will now be described, by way of example, with reference to the accompanying drawings, in which:

FIG. 1 schematically illustrates a scenario context;

FIG. 2 is a schematic block diagram of a design support system which includes a plurality of databases and a security analysis system;

FIG. 3 is a schematic block diagram of the security analysis system shown in FIG. 2;

FIG. 4 is a schematic block diagram of a computer system which is used to implement the security analysis system shown in FIG. 3;

FIG. 5 is a flow diagram of a method performed by the security analysis system shown in FIG. 2;

FIG. 6 illustrates a motor vehicle and an electronic system which is deployable in the motor vehicle;

FIG. 7 illustrates an example of an attack scenario;

FIG. 8 generating a risk profile using scenario data, security analysis data and security mechanism;

FIG. 9 illustrates different risk profiles resulting from different security mechanism data;

FIG. 10 illustrates a first attack tree and generation of a risk level using EVITA;

FIG. 11 illustrates a second attack tree and generation of a risk level using CVSS;

FIG. 12 is flow diagram of a method of automatically selecting a security mechanism in system view mode or domain view mode;

FIG. 13 illustrates automatically selecting the same security mechanism for the same components in domain view mode; and

FIG. 14 is flow diagram of a method of automatically selecting a security mechanism for the same components.

### DETAILED DESCRIPTION OF CERTAIN EMBODIMENTS

### Introduction

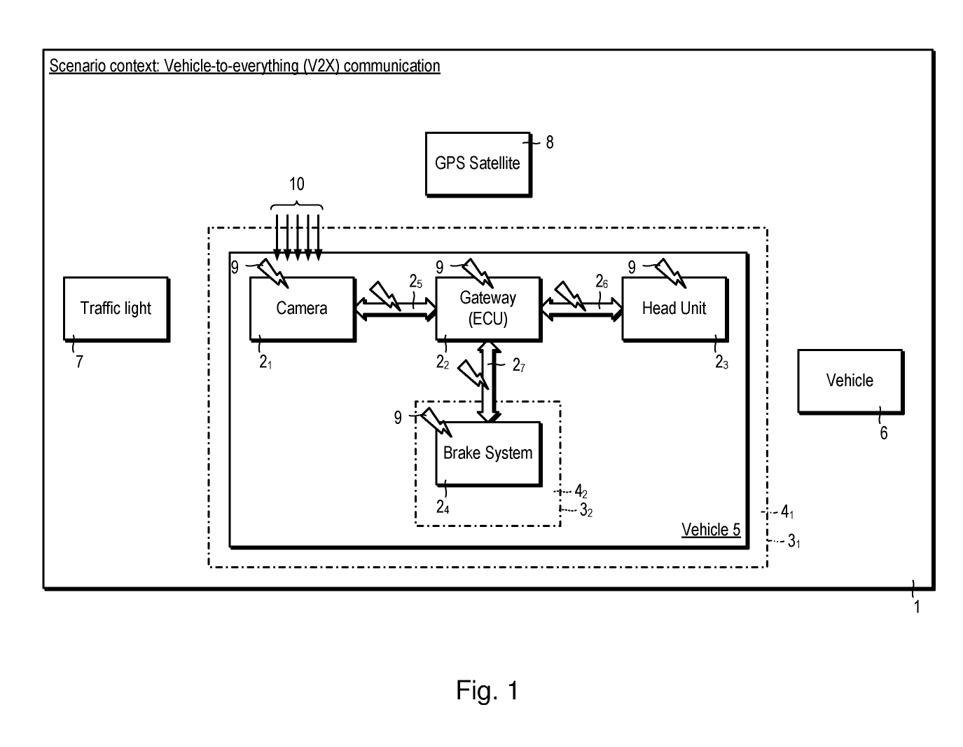

FIG. 1 illustrates a scenario context 1 in which a plurality of electronic assets 2₁, 2₂, 2₃, 2₄, 2₅, 2₆, 2₇ (herein also simply referred to as “assets”) form an electronic system providing a use case (or “feature”), such as automatic emergency braking (AEB).

An asset 2₁, 2₂, 2₃, 2₄, 2₅, 2₆, 2₇ can be hardware and/or software, and examples of assets 2₁, 2₂, 2₃, 2₄, 2₅, 2₆, 2₇ include a camera, a microcontroller, a communication controller in a microcontroller, an electronic control unit (ECU) and first, second and third in-vehicle buses. Different combinations of assets 2₁, 2₂, 2₃, 2₄, 2₅, 2₆, 2₇ can provide different use cases. An asset 2₁, 2₂, 2₃, 2₄, 2₅, 2₆, 2₇ may be shared and be used to provide more than one use case.

Assets 2₁, 2₂, 2₃, 2₄, 2₅, 2₆, 2₇ may be vulnerable to attack by a malicious entity (herein referred to as an “attacker”) from outside the system. Therefore, a system, or a part of system, can be analysed to assess the probability of such attacks occurring and determine their effects. Boundaries 3₁, 3₂ can be defined which define domains of interest 4₁, 4₂. Within a boundary 3₁, 3₂, one or more use cases can be identified and analysed, each use case defined by a particular combination of assets 2₁, 2₂, 2₃, 2₄, 2₅, 2₆, 2₇.

In the following, a vehicle-to-everything (V2X) communication system will be used as an example of a scenario context 1.

Referring to FIG. 1, the V2X communication system 1 may be considered to comprise a first vehicle 5 and other nodes 6, 7, 8, such as a second vehicle 6, a set of traffic lights 7 and a GPS satellite 8.

The assets 2₁, 2₂, 2₃, 2₄, 2₅, 2₆, 2₇ are deployed in the first vehicle 5. A first asset 2₁ takes the form of a camera, a second asset 2₂ takes the form of a gateway, a third asset 2₃ takes the form of a head unit and a fourth asset 2₄ takes the form of a brake system. Fifth, sixth and seventh assets 2₅, 2₆, 2₇ take the form of in-vehicle buses. The camera 2₁ and gateway 2₂ are connected by a first in-vehicle bus 2₅, such as controller area network (CAN) bus or Ethernet, the gateway 2₃ and head unit 2₃ are connected by a second in-vehicle bus 2₆, such as a CAN bus, and the gateway 2₂ and braking system 2₄ are connected by a third in-vehicle bus 2₇, such as a FlexRay bus or a CAN bus.

To help evaluate and minimise the risk of attack, the V2X communication system 1 can be analysed by identifying the use case, an attack goal, one or more attack objectives and respective sets of severity levels for each attack objective. Each attack objective can be broken down into one or more threats 9, and each threat can be broken down into different forms of attack 10. For clarity, only attacks 10 in relation to the camera 2₁ are shown.

In this example, the use case (i.e. feature) is automatic electronic braking and the attack goal is to compromise that use feature, i.e. to compromise automatic electronic braking. In this example, there may be two attack objectives, namely to cause the active braking to activate or not to activate, or to steal intellectual property (IP), such as an algorithm or specific implementation of a process.

Each of attack objective has a respective set of severity classifications, each severity classification reflecting different aspects of security, such as safety, privacy, financial and operational.

In the case of the first attack objective, there may be five threats 9, such as, for example, manipulate camera, manipulate in-vehicle bus, manipulate gateway, manipulate braking system or manipulate head unit. In the case of the second attack objective, there may be one or more similar threats.

Taking the example of the “manipulate camera” threat, an attack to may take the form of fake input, physical attack, software attack, camera by-pass, camera removal or camera replacement. In the case of the manipulate in-vehicle bus threat, an attack may take the form of bus tampering. The probabilities of attack for each threat can be estimated.

One or more security mechanisms may be implemented to make an attack to more difficult and to reduce the chance of such an attack being successful to an acceptably low level. For example, in the case of the fake input attack, authentication may be put in place.

Authentication, however, can be implemented in one or more ways, for example, using one or more different IP cores or blocks. Determining which security mechanisms are effective and should be implemented can be difficult to achieve. The present invention seeks to provide a design support system and a method of generating a risk profile which allows a user to compare different designs of electronic system thereby allowing them to assess security more quickly and/or fully.

### Design Support System 11

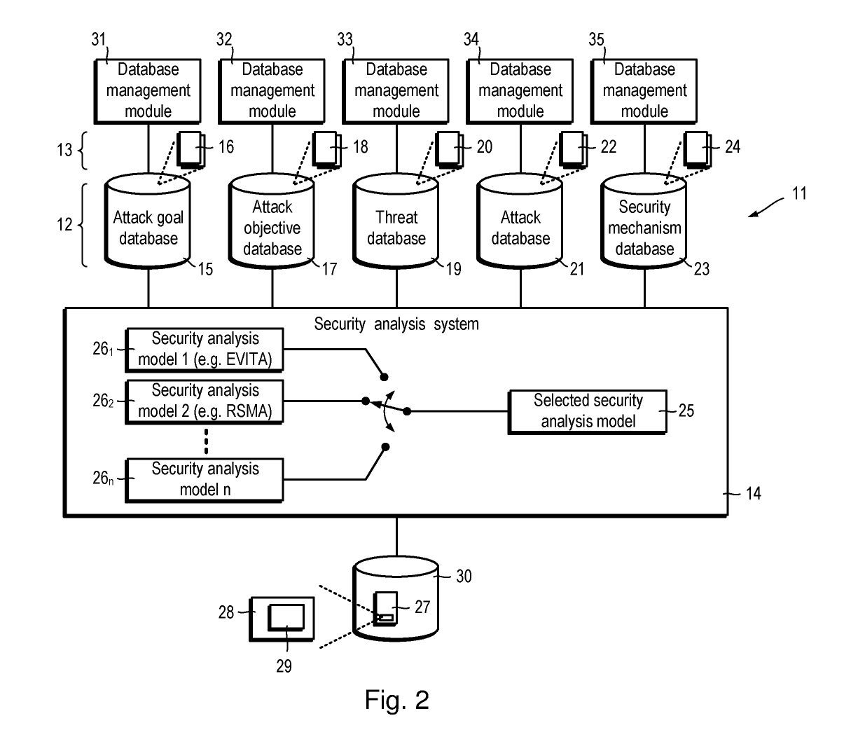

Referring to FIG. 2, a design support system 11 for generating security-related data for at least part of an electronic system is shown. The electronic system may be a network of electronic control units (ECUs) in a motor or other type of vehicle, an industrial control system, a medical system or any another system which is vulnerable to attack.

The design support system 11 comprises a set of databases 12 storing security-related data 13 and a security analysis system 14 (herein also referred to as a “security tool”).

The security-related data databases 12 includes a first security-related data database 15 storing data 16 related to attack goals, such as to compromise automatic emergency braking, a second security-related data database 17 storing data 18 related to attack objectives, such as to cause brakes to be applied, a third security-related data database 19 storing data 20 related to threats, such as manipulate a camera, a fourth security-related data database 21 storing data 22 related to attacks and a fifth security-related data database 23 storing data 24 related to security mechanisms (which may include hardware and/or software security mechanisms). The security mechanism data 24 includes a list of security mechanisms and respective probability-related data relating to how each security mechanism affects a probability-of-success-based score, such as probability of success, P, or a score which depends on probability of success, such as CVSS Base_{score}, for each asset. The probability-related data includes data relating to probability-of-success-based scores for each asset without any security mechanisms applied. A probability-of-success-based score (for example, which can take a value between 1 or some other lower limit and 5 or some other upper limit) can be obtained by testing and/or by analysis, e.g. by a user answering questions in a structured questionnaire. The probability-related data can be stored in a separate database or embedded in the security tool 14. The probability-related data may be defined in terms of probability being unsuccessful.

A probability-of-success-based score is based on a set of parameters including, for example (in the context of EVITA), elapsed time (i.e. how long the attack takes to complete), windows of opportunity, knowledge of the system, equipment and expertise. Elapsed times can be divided into those attacks that take less than a week, those attacks that take less than a month, those attacks that take less than 6 months and those that take more than 6 months to complete. Windows of opportunity can be divided into those that are easy, moderately-difficult, hard and non-practical. The equipment parameter is based on whether the equipment is commercially available, whether it can be replicated from other components and, if so, whether those components are commercially available. Thus, the equipment can be categorised as being standard or specialised. The expertise parameter is used to categorise whether, with the equipment, the attacker can set up and use the equipment to carry out the attack. Expertise is categorised as being low, medium or high. Different parameters may be used in other models, such as CVSS.

As will be explained in more detail later, probability of success of an attack, P, for a given asset can be reduced by applying a security mechanism. For example, if encryption is used, then the time needed to complete an attack is extended and requires a greater level of expertise. Thus, the probability of success of an attack for a given asset will be reduced compared to the situation that encryption is not used.

Security analysis is carried out by using a security analysis model or process 25 selected from a plurality of available security analysis models or processes 26₁, 26₂, . . . , 26ₙ. Examples of security analysis models 26₁, 26₂, . . . , 26ₙ include E-Safety Vehicle Intrusion Protected Applications (EVITA), Reliability, Safety and Mission assurance (RSMA), Common Vulnerability Scoring System (CVSS), a STRIDE and DREAD based security analysis process, or other security analysis process which is applicable to an automotive, industrial, medical or other security-sensitive setting or domain.

The security analysis system 14 generates a report 27 including one or more risk profiles 28. Each profile 28 is based on a probability of success 29, the risk profile 28 being generated using the security-related data 13, and may be stored in an output database 30. The security analysis system 14 can be used to analyse a system or part of a system (such as automatic emergency braking) at a relatively high-level view or a component (such as a communications controller) at a relatively low-level view.

The security-related data 13 can be supplied, revised and deleted by corresponding database management modules 31, 32, 33, 34, 35.

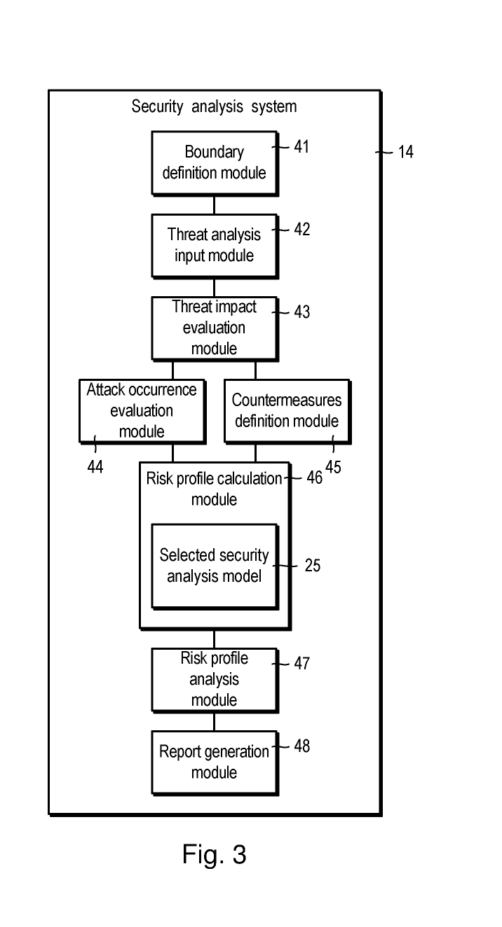

Referring also to FIG. 3, the security analysis system 14 is shown in more detail.

The security analysis system 14 includes a boundary definition module 41, a threat analysis input module 42, a threat impact calculation module 43, an attack occurrence calculation module 44, a countermeasures module 45, a risk profile calculation module 46, a risk profile analysis module 47 and a report generation module 48.

The boundary definition module 41 is used to define a domain of interest (or “system under analysis”) 4₁, 4₂ (FIG. 1). The threat analysis input module 42 is used to specify use cases (which may also be referred to as “features”) within a domain 4₁, 4₂ (FIG. 1), to specify the threats to each use case and to specify attacks related to each threat. Examples of use cases include, for example, automatic emergency braking (AEB) system, type pressure monitoring system, audio and entertainment/multimedia system and flashing per on-board diagnostics (OBD). The threat impact calculation module 43 is used to estimate a threat severity, S. The attack occurrence calculation module 44 estimates the attack probability, P. The countermeasures module 45 defines a selectably-enableable security mechanism, SM, which can cover one or more attacks. A security measure may be specified in terms of type and level. A security measure may be software-based, for example, software-based cryptographic routines such as Advanced Encryption Standard (AES), Elliptic curve cryptography (ECC), Rivest-Shamir-Adleman (RSA) and pseudo-random number generator (P-RNG), or software-based hash functions, such as secure hash algorithm (SHA). A security measure may be hardware-based, such as such AES, ECC, RSA and T-RNG. A hardware security module may be used. A security measure may be physical, such as placement randomisation and shielding, and power signature cloaking.

The risk profile calculation module 46 calculates a risk profile, for example, a security level, R. The risk profile may be calculated with and without a security mechanism applied. If a security mechanism is applied, then the risk profile is a function of security mechanism impact, SMi, which measures the effectiveness that a security mechanism has to reduce the probability of attack. The profile analysis module 47 allows a user to compare risk profiles before and after a security measure is put in place. Thus, a user can evaluate the effectiveness of a given security measure and compare different security measures.

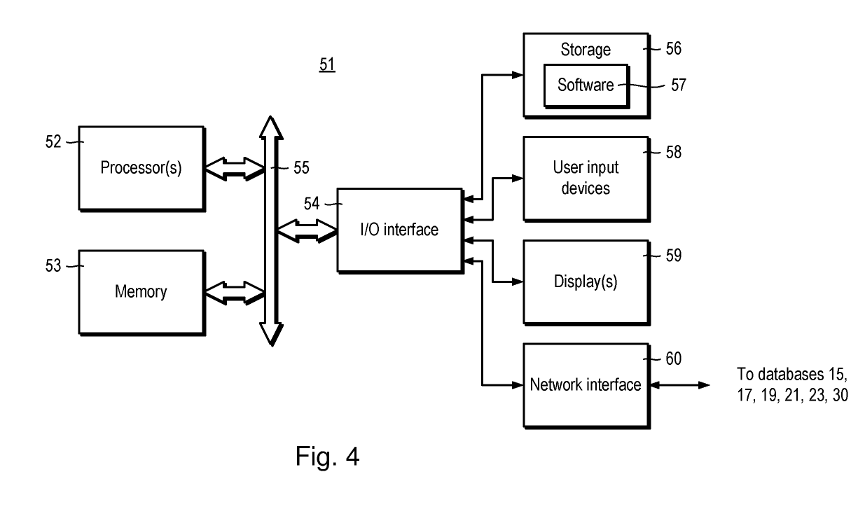

Referring also to FIG. 4, the security analysis system 14 is implemented in a computer system 51.

The computer system 31 includes at least one processing core 52, memory 53 and input/output interface 54 interconnected by a bus system 55. The computer system 51 includes local storage 56 which stores design support software 57 for implementing one or more of the modules 41, 42, 43, 44, 45, 46, 47, 48. However, the design support software 57 can be stored on an application server (not shown). The computer system 51 also includes user input devices 58, such as keyboards and/or pointing device(s), one or more displays 59 and a network interface 60. The network interface 60 provides a connection to databases 15, 17, 19, 21, 23, 30. The computer system 51 implements license control of the databases 15, 17, 19, 21, 23, 30 so that each user has a respective set of access rights.

The security analysis system 14 can be a distributed system.

The design support system 11 allows a developer to assess the impact of different security mechanisms, such as software-based encryption or hardware security modules, and so identify which security mechanisms should be implemented.

### Overview of Security Analysis

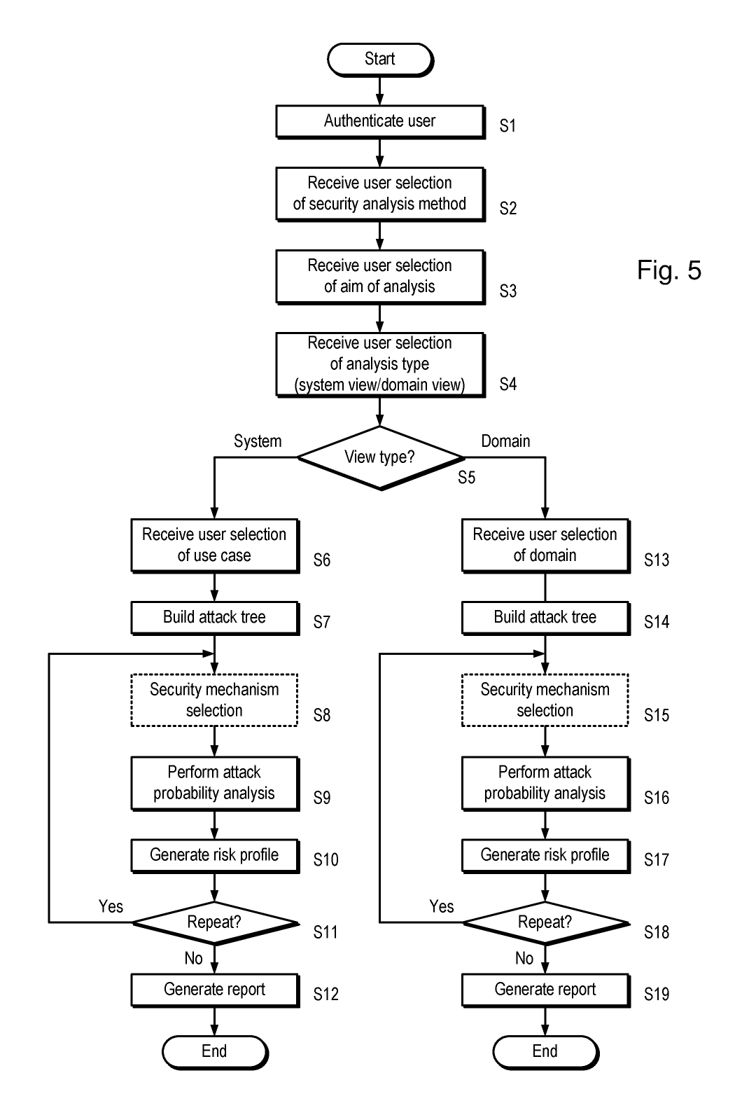

Referring to FIGS. 2, 3 and 5, a method of generating a risk profile will now be described.

A user (not shown) logs onto the security analysis system 14 which identifies and authenticates the user (step S1). Based upon the identity of the user, the security analysis system 14 sets appropriate access rights to the security-related data databases 12.

The security analysis system 14 prompts the user to select a security analysis framework, such as EVITA, and the aim of the analysis, namely whether to explore a design of an electronic system or to validate an existing design (steps S2 & S3). The security analysis system 14 prompts the user to select the type of analysis to be used, namely a top-level view (or “system view”), a lower-level view, such as domain-level view, sub-system-level view, component-level view (i.e. a microcontroller) (steps S4 & S5).

In system view mode, the security analysis system 14 prompts the user to select or input a use case, such as, for example, tyre pressure monitoring or emergency automatic braking (step S6). For a given use case, the security analysis system 14 receives selections from the user to build a scenario in the form of an attack tree (step S7). The security analysis system 14 prompts the user to select one or more security mechanisms (step S8). However, the user need not select a security mechanism. For example, the user may want to conduct analysis initially without any security mechanism applied. Based on the scenario and selected security mechanism(s), the security analysis system 14 carries out attack probability analysis (step S9) and generates a risk profile (step S10). The security analysis system 14 prompts the user whether they wish to repeat the process (step S11) and if so, allows the user to make changes, and, if not, generates and outputs a report (step S12).

In domain view mode, the security analysis system 14 prompts the user to select or input a domain (step S13). For a given domain (or other chosen level), the security analysis system 14 receives selections from the user to build a scenario in the form of an attack tree (step S4). The security analysis system 14 prompts the user to select one or more security mechanisms (step S15). However, the user need not select a security mechanism. For example, the user may want to conduct analysis initially without any security mechanism applied. For a given domain and selected security mechanism(s), the security analysis system 14 carries out attack probability analysis (step S16) and generates a risk profile (step S17). The security analysis system 14 prompts the user whether they wish to repeat the process (step S8) and if so, allows the user to make changes, and, if not, outputs a report (step S19).

### Use of Security Analysis

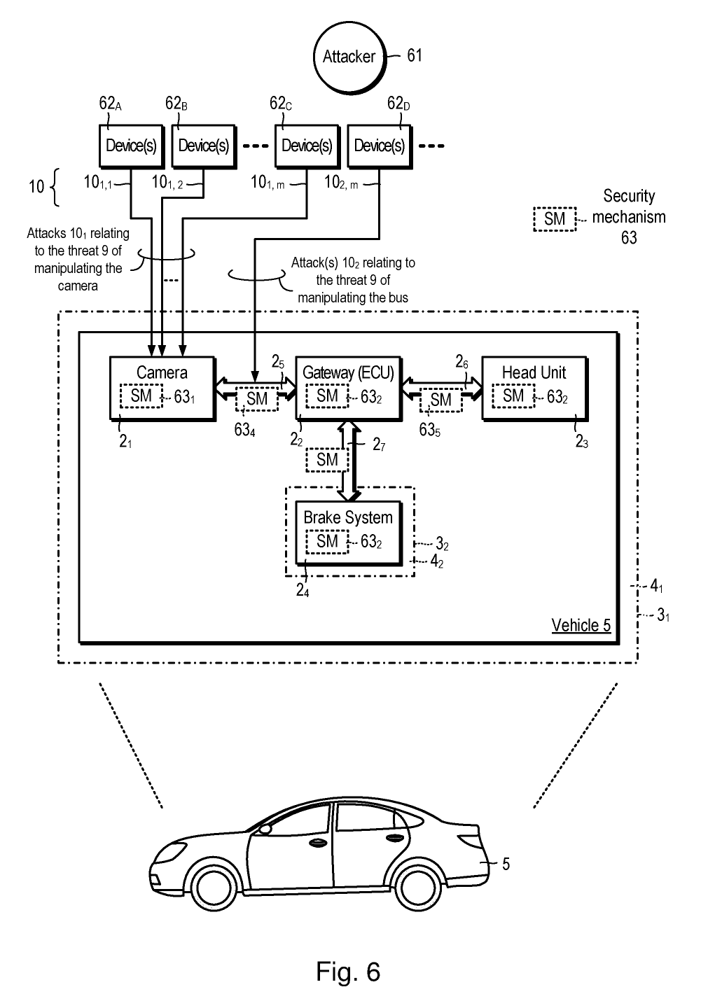

FIG. 6 illustrates a motor vehicle 5 and an electronic system which is deployable in the motor vehicle 5 and which can be the subject of security analysis using the design support system 11 (FIG. 2).

As explained earlier, within a defined boundary 3, of the vehicle 5, the automatic emergency braking use case can be identified and analysed.

According to a possible attack scenario, an attacker 61 can use one or more devices 62_{A}, 62_{B}, 62_{C}, 62_{D} to carry out an attack to on the system. The design support system 11 (FIG. 2) is used to assess the security of the system and whether one or more security measures 63₁, 63₂, 63₃, 63₄, 63₅, 636, 63₇ should be introduced into one or more assets 2₁, 2₂, 2₃, 2₄, 2₅, 2₆, 2₇.

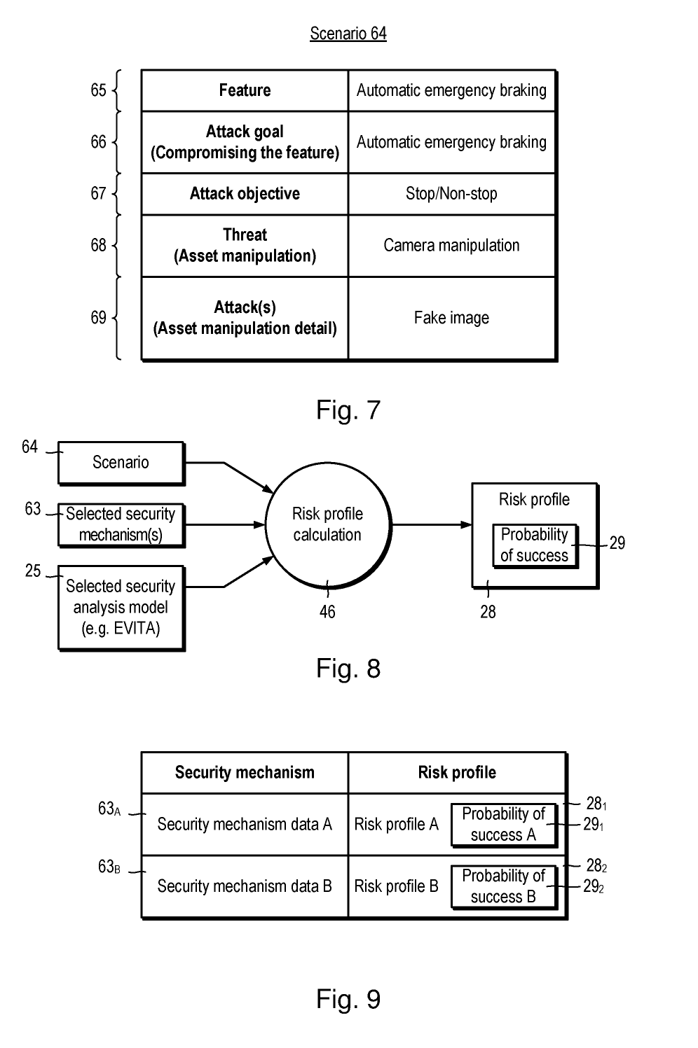

FIGS. 7, 8 and 9 illustrate data and the security process carried out by the security analysis system 14 (FIG. 2) in respect of the electronic system.

Referring to FIG. 7, a user (not shown) can specify a scenario 64 comprising a feature 65, an attack goal 66, an attack objective 67, a threat 68 and an attack 69. In this example, the feature 65 takes the form of automatic emergency braking, the attack goal 66 takes the form of compromising automatic emergency braking, the attack objective 67 takes the form of causing the vehicle to stop/not stop, the threat 68 takes the form of manipulation of a relevant asset, in this case the camera, and the attack 69 in this case takes the form of introducing a fake image.

For a given threat 68, there may be one or more forms of attack 69. For a given attack objective 67, there may be one or more different threats 68. For a given attack goal 66, there may be one or more different attack objective 67.

The user (not shown) can specify each aspect 65, 66, 67, 68, 69 of a scenario 64 by selecting an aspect from a respective list, e.g. in the form of a pull-down menu. The user can also select the security mechanism from a list, e.g. in the form of a pull-down menu.

Referring to FIG. 8, scenario data 64, a selected security mechanism 63, which is selected from the list of security mechanisms in security mechanism data 25 (FIG. 2), and security analysis model or process are supplied to the risk profile calculation module 46 (FIG. 3) which performs a risk profile calculation and generates a risk profile 28 which is based on a probability of success 29.

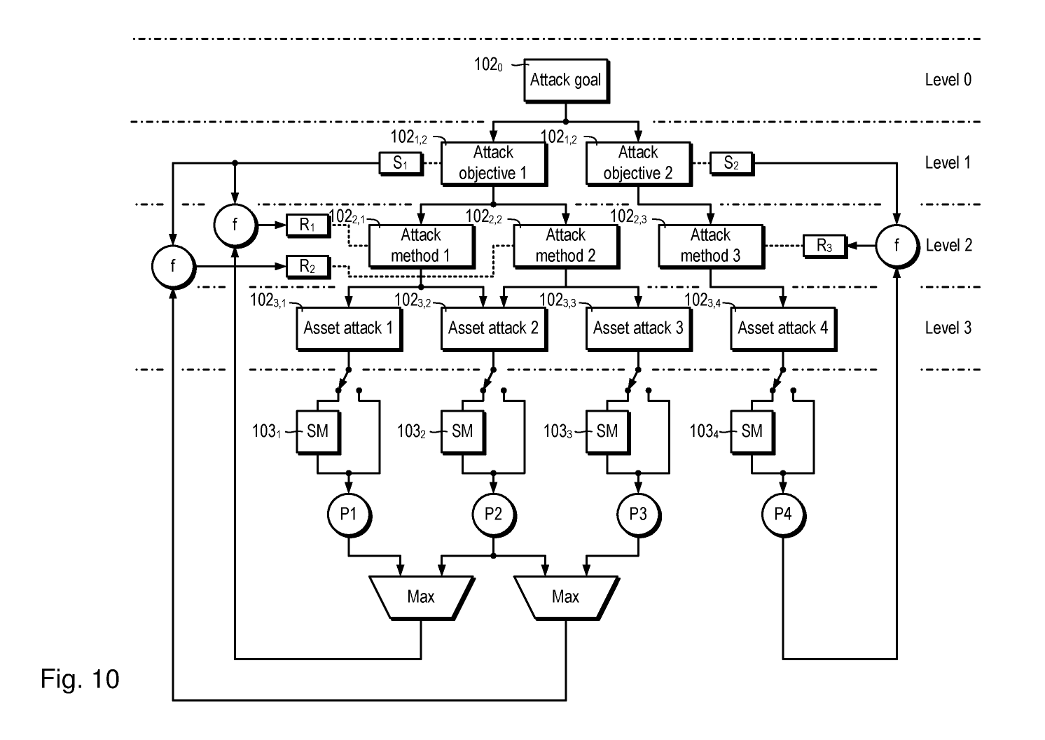

Referring also to FIG. 9, different selected security mechanisms 63_{A}, 63_{B} result in respective risk profiles 28₁, 28₂ having respective probabilities of success 29₁, 29₂. The risk profiles 28₁, 28₂ may differ and the probabilities of success 29₁, 29₂ may differ. Thus, the security mechanisms 63_{A}, 63_{B} resulting in the lower probability can be selected as a countermeasure against the attack.

The risk profile 28 depends on the selected security analysis model 25.

In EVITA and RSMA, a risk level, R, is a function, ƒ, of severity, S, and probability, P, namely:

R=ƒ(S,P) (1)

The risk profile calculation module 26 takes into account a security mechanism impact, SMi. Thus, the risk level, R, is a function of security mechanism impact, SMi, namely:

R=ƒ(S,P(SMi)) (1′)

Similarly, in CVSS, a risk level, R, us a function, ƒ, of Base_{score}, namely:

R=ƒ(Base_{score}) (2)

The risk profile calculation module 26 takes into a security mechanism impact, SMi. Thus, the risk level, R, is a function of security mechanism impact, SMi, namely:

R=ƒ(Base_{score}(SMi)) (2′)

The security analysis system 14 can be used to calculate a risk profile according to a given security analysis method as a function of one or more security mechanisms.

### Risk Calculation

FIG. 10 illustrates how the risk profile is calculated using EVITA.

Referring to FIG. 10, a first attack tree 101 comprises a root node 102₀ and nodes 102_{1,1}, 102_{1,2} . . . 102_{L,N}, 102_{3,3}, 102_{3,4} arranged in series of levels, L, from Level 0 to Level 3.

In Level 0, the root 102₀ represents the attack goal. In Level 1, the nodes 102_{1,1}, 102_{1,2} represent the attack objectives, each having a respective associated severity, S₁, S₂. In Level 2, the nodes 102_{2,1}, 102_{2,2}, 102_{2,3} represent the attack methods. For each attack method, a respective associated risk level, R₁, R₂, R₃, is calculated. In Level 3, the nodes 102_{3,1}, 102_{3,2}, 102_{3,3}, 102_{3,4} represent the asset attacks.

For each asset attack, a security mechanism 103₁, 103₂, 103₃, 103₄ can be selected and a corresponding probability of attack, P, is calculated.

As will be explained in more detail later, the security analysis system 7 may select a security mechanism which minimises the probability of attack. This can be done as follows:

Choose the x-th security mechanism, SMx, such that:

SMx∈S={SM1, . . . ,SMn} (3)

where S is the set of all security mechanisms SM1, . . . , SMn that can be applied to that specific attack and

P_{SMx}=min{P_{SM1}, . . . ,P_{SMn}} (4)

where P_{SMi} (where i=1, . . . n) is the attack probability after a security mechanism SMi has been applied.

Where an attack method affects more than one asset attack, corresponding probabilities (for example P₁, P₂ in the case of attack method 1 and P₂, P₃ in the case of attack method 2) are compared and the maximum probability max {Pₐ, P_{b}, . . . } is selected. This is used to calculate the risk, R. In the case of attack method 1, max {P₁, P₂} is used to calculate R₁ and in the case of attack method 2, max {P₂, P₃} is used to calculate R₂.

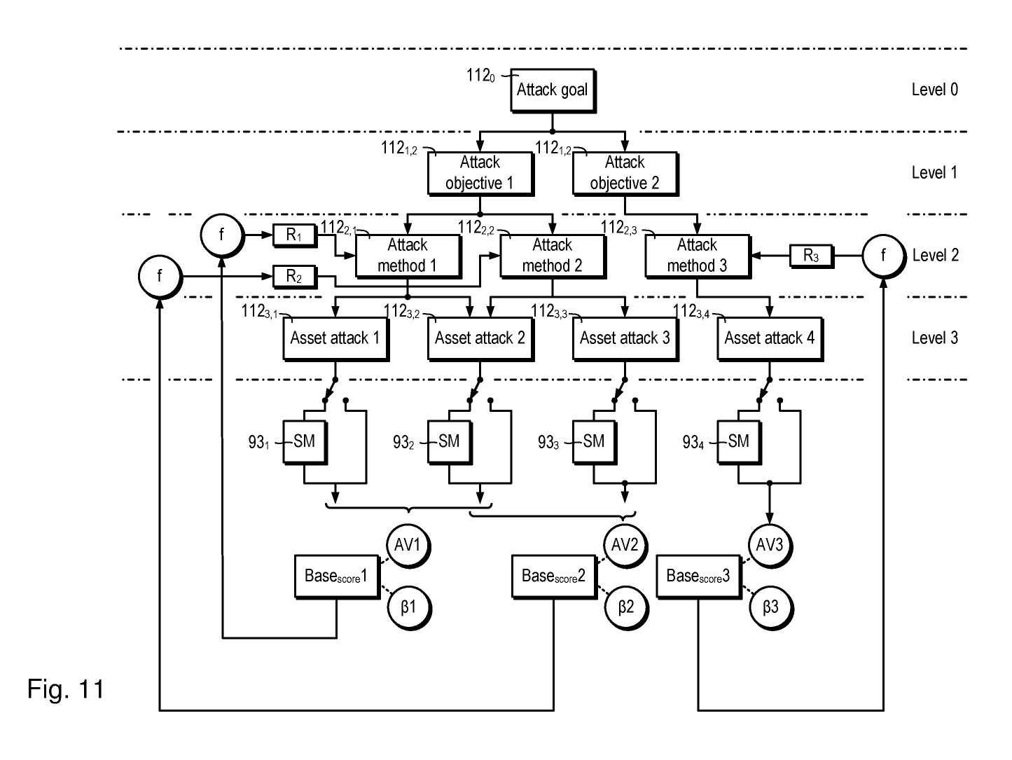

FIG. 11 illustrates how the risk profile is calculated using CVSS.

Referring to FIG. 11, a second attack tree 111 comprises a root node 112₀ and nodes 112_{1,1}, 112_{1,2} . . . 112_{L,N}, 112_{3,3}, 112_{3,4} arranged in series of levels, L, from Level 0 to Level 3.

For each attack method, a respective associated access vector level, AV1, AV2, AV3, and other CVSS parameter is calculated which in turn are used to calculate a CVSS Base_{score}. For each attack method, a respective associated risk level, R₁, R₂, R₃, is calculated.

### Security Mechanism Selection

The security analysis system 14 can present the user with an option to allow the security analysis system 14 to select automatically (i.e. on the user's behalf) a security mechanism which achieves a user-specified minimum security profile.

If the user selects automatic security mechanism selection, then the security analysis system 7 performs the following process instead of, for example, steps S8 and S9 or steps S15 and S16 hereinbefore described.

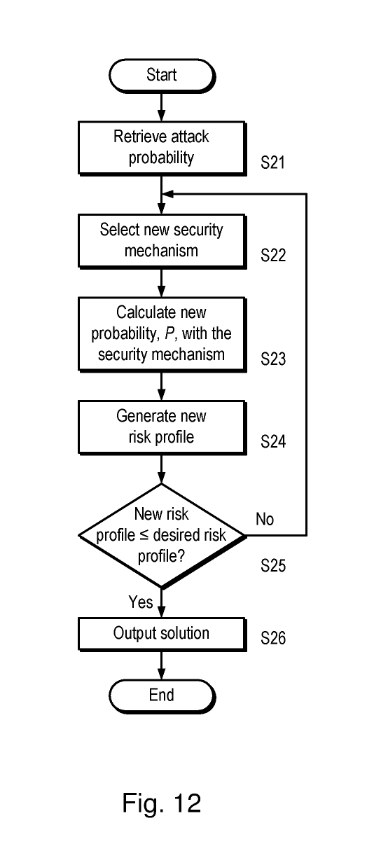

Referring to FIG. 12, the security analysis system 14 selects attack probability (step S21) and selects a security mechanism (step S22).

The security analysis system 14 calculates a new probability, P, based on the currently selected security mechanism (step S23). Using the probability, P, the security analysis system 14 generates a new risk profile including a new risk level, L (step S24). The security analysis system 14 compares the new risk profile with the desired risk profile, e.g. by comparing L and L_{desired} (step S25).

If the new risk profile is satisfactory, e.g. if L≤L_{desired}, then the security analysis system 14 outputs a report 27 (FIG. 2), which identifies the selected security measure (step S26). Otherwise, the security analysis system 14 selects another security mechanism (step S22).

In the case that a risk profile is found to be acceptable, the security analysis system 14 can select another security measure and repeat the process until all security measures are checked, until a pre-determined number of security measures are checked or until instructed to stop by the user.

The security analysis system 14 may select security measures in a pre-determined order, e.g. starting from simpler and/or cheaper security measures and proceeding to more complex and/or expensive security measures.

Automatic security mechanism selection can be helpful since effective security mechanisms tend to be specific to the attack and can be difficult or time-consuming for the user to find manually.

### Security Mechanism Selection for the Same Components

The security analysis system 14 can also present the user with an option to choose whether the security analysis system 14, for a specific attack, automatically selects the same security mechanism for all attacks which are linked to same component, such as a communications controller.

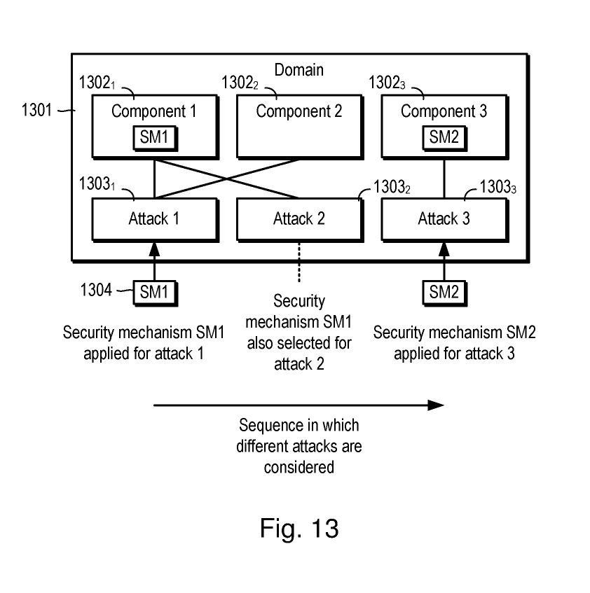

Referring to FIG. 13, an automotive or industrial domain 1301, such as the body domain, is shown.

The domain 1301 includes first, second and third components 1302₁, 1302₂, 1302₃ which may be affected by first, second and third attacks 1303₁, 1303₂, 1303₃. In particular, the first component 1302₁ is affected by the first and second attacks 1303₁, 1303₂, the second component 1202₂ is affected by the first attack 1303₁ only and the third component 1302₃ is affected by the third attack 1303₃ only.

A security mechanism 1304 is found to be effective for the first component 1302₁ for the first attack 1303₁ using a process hereinbefore described.

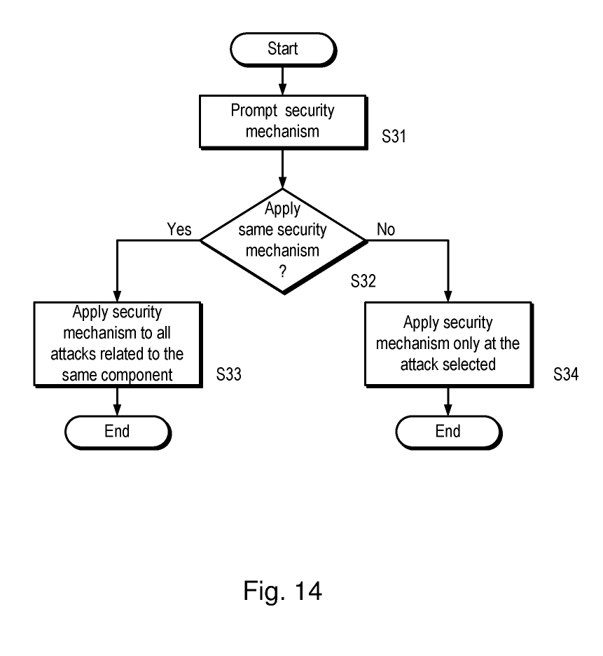

Referring also to FIG. 14, when the user comes to use the security analysis system 14 again to analyse the same domain 1301, but a different attack, the security analysis system 14 notifies the user that a security mechanism is already available for the first component 1301₁ and prompts the user whether the same security mechanism 1304 should be applied (step S31).

If the user provides an instruction that the same security mechanism 1304 should be used for the second attack 1303₂, the security analysis system 14 automatically applies the same security mechanism 1204 for the first attack 1303₁ to the first component 1301₁, for the second attack 1303₂ (step S33). The security analysis system 14 can then be used to select an appropriate security mechanism, if any, for the third component 1301₃.

If, however, the user provides an instruction that the same security mechanism should not be used and that a security mechanism for the second attack 1303₂, then the security analysis system 14 is used to select an appropriate security mechanisms, for the first and third components 1301₁, 1301₃ (step S34).

Automatic security mechanism selection for the same component can help the user to assemble a set of security measures in a domain.

It will be appreciated that many modifications may be made to the embodiments hereinbefore described. Such modifications may involve equivalent and other features which are already known in the design, manufacture and use of design support systems and component parts thereof and which may be used instead of or in addition to features already described herein. Features of one embodiment may be replaced or supplemented by features of another embodiment.

A probability in relation to an attack can be expressed in terms of a probability of an attack being unsuccessful.

Elapsed times can be defined with upper and lower limits and, optionally, one or more intermediate limits.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. A method of generating a risk profile for at least part of an electronic system which is vulnerable to an attack originating from outside the system, the method comprising:
receiving an attack scenario identifying an attack and a potential target for the attack within the at least part of the system;
receiving a selection, from a user, of a security analysis model for assessing the attack;
receiving information identifying a selected security mechanism appliable in the at least part of an electronic system; and
generating a risk profile in dependence upon the selected security mechanism.

2. A method according to claim 1, further comprising:
generating a report which includes the risk profile.

3. A method according to claim 2, wherein the report includes another risk profile without the selected security mechanism applied.

4. A method according to claim 1, wherein receiving information identifying the selected security mechanism comprises:
receiving a selection, from the user, of a security mechanism.

5. A method according to claim 1, further comprising:
selecting a security mechanism according to a predetermined method;
generating a risk profile in dependence upon the security mechanism;
determining whether the risk profile meets a predetermined criterion; and
in dependence upon determining that the risk profile meets the predetermined criterion, identifying the security mechanism as the selected security mechanism.

6. A method according to claim 1, wherein the attack scenario is a first attack scenario and the risk profile is a first risk profile, wherein the method further comprises:
receiving a second attack scenario identifying a second, different attack and the same target; and
generating a second risk profile in dependence upon the security mechanism.

7. A method according to claim 6, further comprising:
prompting the user as to whether the security mechanism is to be used for the second attack.

8. A method according to claim 1, wherein the at least a portion of the system comprises a domain.

9. A method of according to claim 1, wherein the electronic system is an automotive electronic system.

10. A method of according to claim 1, wherein the electronic system is an industrial electronic system.

11. A method of designing an electronic system, the method comprising:
generating a risk profile for at least part of the electronic system according to any preceding claim;
including the security mechanism in a design of the at least part of the electronic system; and
storing the design.

12. A method, comprising:
designing an electronic system according to claim 11; and
manufacturing a product incorporating the electronic system embodying a design comprising the design of the at least part of the electronic system.

13. A product manufactured by a process according to claim 12.

14. A product according to claim 13, which is vehicle.

15. A computer program product comprising a non-transitory computer-readable medium storing a computer program which, when executed by data processing apparatus, causes the data processing apparatus to perform a method according to claim 1.

16. A design support system which includes data processing apparatus comprising:
at least one processor; and
memory;
wherein the least one processor is configured to perform a method according to claim 1.

17. A product according to claim 14, wherein the vehicle is a motor vehicle.
